(19) United States
(12) Patent Application Publication
(10) Pub. No.: US 2016/0063744 A1
(43) Pub. Date: Mar. 3, 2016

(54) Data Quality Test and Report Creation System

(71) Applicant: Schlumberger Technology Corporation, Sugar Land, TX (US)

(72) Inventor: Stephen Freeman, Notts (GB)

(21) Appl. No.: 14/843,521

(22) Filed: Sep. 2, 2015

Related U.S. Application Data
(60) Provisional application No. 62/044,470, filed on Sep. 2, 2014.

(51) Int. Cl. G06T 11/20; G06F 3/0486

(52) U.S. Cl. CPC G06T 11/206; G06F 3/0486

(57) ABSTRACT

Embodiments relate to systems, devices, and computer-implemented methods for creating data quality tests and reports. A test creator interface for creating a test can be displayed for a user, and the user can select components of the test, select inputs for the components, and providing testing rules. Further, a report creator interface for creating a report template can be displayed for the user, and the user can provide instructions for displaying results of the test.

### CROSS-REFERENCE TO RELATED APPLICATIONS

This application claims priority to U.S. Provisional Patent Application having Ser. No. 62/044,470, which was filed on Sep. 2, 2014, and is incorporated herein by reference in its entirety.

### BACKGROUND

Workers in various organizations utilize and often rely on software systems to perform their work. For example, in the oil and gas industry, an exploration and production sector (E&P) software system allows users to interpret seismic data, perform well correlation, build reservoir models suitable for simulation, submit and visualize simulation results, calculate volumes, produce maps, and design development strategies to maximize reservoir exploitation.

In practice, the data produced through such software systems may call for some amount of quality assurance testing to ensure accuracy of the data. However, the generation of quality assurance tests and the production of reports based on the tests can be a labor-intensive task and call for experienced user control. Additionally, there are numerous inefficiencies in generating and running the tests, and redundancy in the creation of the same or similar tests by multiple users.

### SUMMARY

Systems, apparatus, computer-readable media, and methods are disclosed for creating and using test and report templates.

In at least one embodiment, a test creator interface can be provided for creating a test. The test creator interface can receive a selection of components of the test, receive indications of inputs of the test, where each input is associated with a component, and receive testing rules corresponding to the components and the inputs, where the testing rules are associated with results. A report creator interface can be provided for creating a report template associated with the test, and the report creator interface can receive instructions for displaying the results in the report template.

In at least one embodiment, the test and the report template can be shared by receiving an indication of a level of publication of the test and report template, determining a list of users for sharing the test and report template based on the level of publication, and providing the test and report template to the users.

In at least one embodiment, the test can be run by displaying an input interface associated with the test, receiving user inputs, processing the user inputs based on the testing rules to obtain results, and generating a report based on the report template and the instructions for displaying the results.

In at least one embodiment, the report can be shared by receiving an indication of a level of publication of the report, determining a list of users for sharing the report based on the level of publication, and providing the report to the users.

In at least one embodiment, the report creator interface can further receive instructions for displaying indications of the components.

In at least one embodiment, the test creator interface and the report creator interface can be drag and drop interfaces.

In at least one embodiment, the test creator interface and the report creator interface can receive indications of the inputs, receive the testing rules, or receive instructions for displaying the results from a user via macro programming language.

In at least one embodiment, the report creator interface can further receive a publication format associated with the report template.

It will be appreciated that this summary is intended merely to introduce a subset of aspects of the disclosure, presented below. Accordingly, this summary is not to be considered limiting on the disclosure.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a flow diagram illustrating an example of creating a test and report template, consistent with certain disclosed embodiments;

FIG. 2 is a schematic depicting an example test creator interface, consistent with certain disclosed embodiments;

FIG. 3 is a schematic depicting an example report creator interface, consistent with certain disclosed embodiments;

FIG. 4 is a flow diagram illustrating an example of using a test and report template, consistent with certain disclosed embodiments;

FIG. 5 is a schematic depicting an example input interface, consistent with certain disclosed embodiments;

FIG. 6 is a schematic depicting an example report, consistent with certain disclosed embodiments;

FIG. 7 is a diagram illustrating an example of a hardware system for providing a test and report creation system, consistent with certain disclosed embodiments; and

FIG. 8 is a schematic depicting an example of code in a macro programming language used to generate a test, consistent with certain disclosed embodiments.

### DETAILED DESCRIPTION

The following detailed description refers to the accompanying drawings. Wherever convenient, the same reference numbers are used in the drawings and the following description refers to the same or similar parts. While several examples of embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

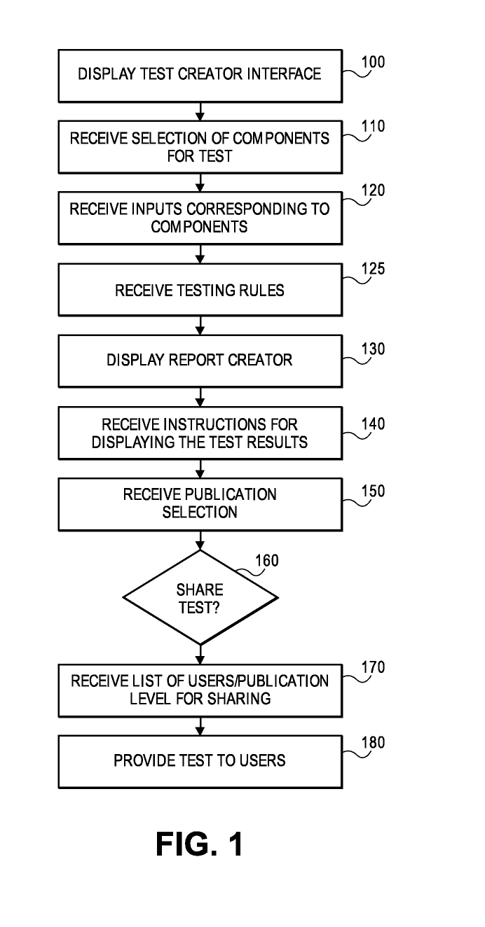

FIG. 1 is a flow diagram illustrating an example of creating a test and report template. The method can be performed on a computing device, such as a computing device configured and/or designed to run a specific software system. For example, the computing device can be configured to run an E&P software system.

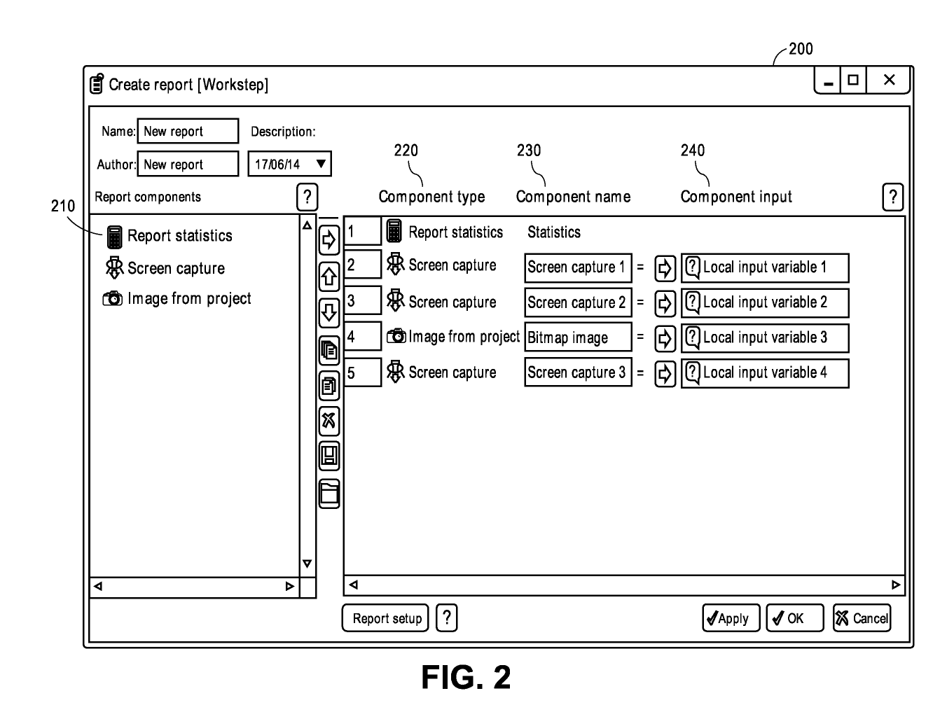

The example of the method shown can begin in 100, when the computing device displays a test creation interface for a user. An example test creation interface is shown in FIG. 2. Using the test creation interface, the user can enter test components and inputs that can be used to perform a test and generate a report.

In 110, the computing device can receive, via the test creation interface, a selection of components for a test. For example, a component can be a report statistics component that can be used to calculate and display various statistics associated with the test. In some embodiments, the report statistics component may not call for an input from the user to perform the test, and, accordingly, the user may not need to select an input for the report statistics component to create the test. Instead, the report statistics component can be associated with and/or utilize one or more results of the testing.

As an additional example, a component can be a screen capture component that can be used to capture an image, sequence of images, and/or data displayed by the software system and parse the captured data and/or data extracted from the captured image(s). In some embodiments, a screen capture component associated with an E&P software system can be used to capture seismic data, well correlations, reservoir models, simulation results, volumes, maps, and development strategies displayed by the E&P software system.

As a further example, a component can be an image component that can be used to display an image in a report. In some embodiments, the image may be a variable image that is created or changed by the software system and/or during the testing. For example, images can include, but are not limited to, slices through data objects such as seismic cubes or sections through reservoir simulation models, charts from data objects such as histogram and function plots, and maps of surfaces.

In some embodiments, the test creation interface can be a graphic user interface (GUI) and selection of components can be received from the user using drag and drop commands via the GUI. In further embodiments, the user can select components using a macro programming language.

In some implementations, the user can assign identifiers to the components for use in inputting the testing rules and generating the report. In other embodiments, identifiers can be automatically assigned to the components.

In 120, the computing device can receive, via the test creation interface, a selection of inputs for a test. In some embodiments, each input can be associated with a selected component from 110. For example, inputs can be one or more of text, images, models, simulation results, maps, and/or any other data produced, retrieved, or utilized by the software system and/or by the user.

In some implementations, some types of components can call for inputs, some types of components may not call for inputs (i.e., an input is optional), and some types of components may not allow inputs. In still further implementations, a component can call for a specific type of input (e.g., an image, a proprietary file of the software system, or text), can call for a specific number inputs, etc.

In some embodiments, the test creation interface can be a GUI and selection of inputs can be received from the user using drag and drop commands via the GUI. In further embodiments, the user can select inputs using a macro programming language.

In some implementations, the user can assign descriptions to the inputs. For example, the descriptions can be used to describe the inputs needed when using the created test.

In 125, the computing device can receive testing rules for each component. In some embodiments, the user can input instructions (e.g., via the macro programming language) that instruct the computing device how to perform the test using the inputs associated with the components and/or the results of tests on the components. For example, the user can create a testing rule that generates a result value based on an input of a component. The testing rule can further compare the result value to a threshold value and set a variable of a report statistics component based on whether the result value is greater than, less than, or equal to the threshold (e.g., a pass/fail/caution value, as described below).

In some implementations, the user can assign identifiers to the results of the testing for use in generating the report template. For example, data objects can be assessed for their consistency with expected value ranges for that data object type. That result can then be passed into the report.

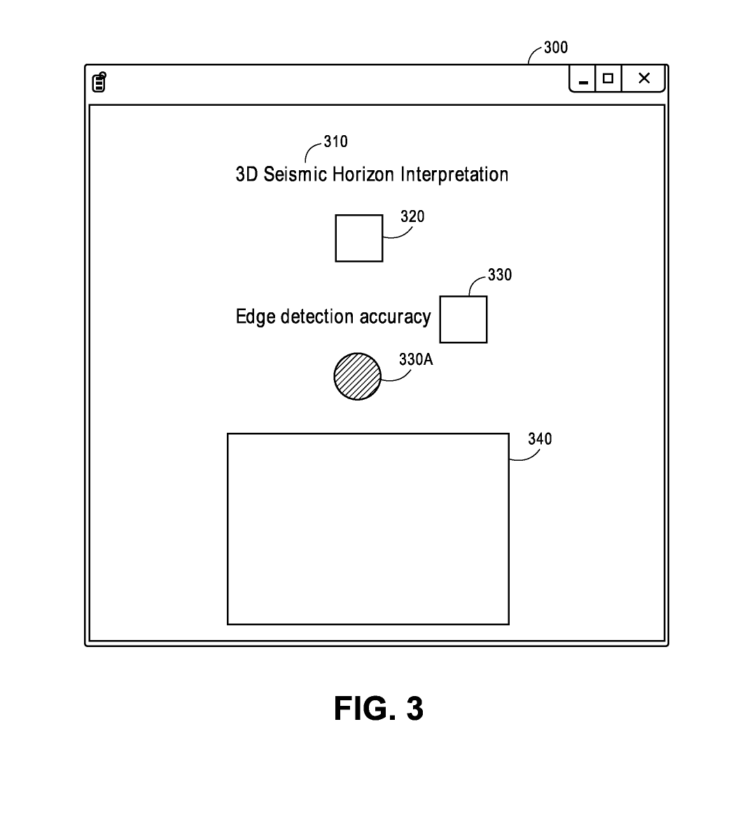

In 130, the computing device can display a report creation interface. An example report creation interface is shown in FIG. 3.

In some embodiments, the report creation interface can be a GUI and can allow the user to select results (e.g. using the user assigned identifiers) or select components from the created test and manipulate and position a display element associated with the selected results or selected components in the report. Using the report creation interface, the user can create a report template associated with the test created in 100-125.

In 140, the computing device can receive instructions for displaying the test results. In some embodiments, the user can select a display element type using the GUI and drag and drop the display element to a desired location in the report template. In further embodiments, the user can adjust the size and/or orientation of display elements in the report template. In still further embodiments, the user can select display options associated with the display element, assign a function to the component, and/or associate components with the results or the components of the test.

In some embodiments, the user can select a display element and associated it with a report statistics component of the test and add the display element to the report. The user can additionally assign a function to the report statistics component. For example, the user can create a function (e.g., using a macro programming language) that compares a variable of the report statistics component to a threshold and sets a pass/fail/caution value as pass, fail, or caution based on the result. The user can further select a display option associated with the report statistics component. For example, the user can set a display color of the report statistics component to green if the pass/fail/caution value is pass, red if the pass/fail/caution value is fail, and orange if the pass/fail/caution value is caution.

In further embodiments, the user can select a display element and associated it with a screen capture component of the test and add the display element to the report. The user can further select a display option associated with the screen capture component. In some embodiments, a screen capture can be set to control the visualization area such that at least a portion of data objects can be captured. For example, a screen capture can capture maps depicting an entire surface or maps showing the surface around specific points or areas of interest.

In other embodiments, the user can select a display element and associated it with an image component of the test and add the display element to the report. The user can further select a display option associated with the image component. For example, the user can select to crop the image to show a particular subset of the image and/or apply additional image manipulation techniques to the image.

In some embodiments, the user can select a display element and associated it with a result of the testing using the user assigned identifiers. The user can additionally select a location of the display element associated with the result in the report.

In further embodiments, the user can add static text and or images to the report to, for example, explain the significance of what is shown, identify the report, identify the name of the creator, identify the name of an organization, include a logo of the organization, etc.

In 150, the computing device can receive publication selection from the user. In some embodiments, the user can select to publish the report in one or more different formats (e.g., a word processing document, a Hypertext Markup Language (HTML) webpage, etc.). In further embodiments, the user can select whether to share the test with other users.

If, in 160, the user selects not to share the test with other users, the process can end, and the user can use the created test and report template to perform testing on data created by the software system. The test will continue to be associated with the components and inputs, so, accordingly, the test can be automatically re-run based on new input from the software system. If, in 160, the user selects to share the test and report template with other users, the process can proceed to 170.

In 170, the computing device can receive a list of users and/or a publication level for sharing the test and report template. In some embodiments, the user can provide a list of one or more usernames of users that use the same software system for sharing the test and report template. In other embodiments, the user can specify a publication level for sharing the test and report template. Examples of publication levels include, but are not limited to, global publication (i.e., no restrictions), publication within an organization, publication within a specific division of an organization, publication to a predetermined group of users, etc.

In 180, the computing device can then transmit a copy of the instructions for performing the test and the report template to each user based on the usernames and/or each user in a group associated with a publication level. Accordingly, each user can subsequently use the created test and report template to perform testing on data created by the software system. The test will continue to be associated with the components and inputs, so, accordingly, the test can be automatically re-run based on new input from the software system.

While the operations depicted in FIG. 1 have been described as performed in a particular order, the order described is merely an example, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. For example, in 110 and 120, a selected component may call for an input selection before a subsequent component can be select for the test. Further, the operations described are not intended to be exhaustive or absolute, and various operations can be inserted or removed.

FIG. 2 is a schematic depicting an example test creator interface, consistent with certain disclosed embodiments. Test creator interface 200 can be, for example, an HTML webpage displayed on a web browser or a stand-alone application running on a user's computer.

Test creator interface 200 can include a listing of component types 210. The listing of component types can allow a user to select a component type for a test. Example component types include a report statistics component type, a screen capture component type, and an image component type, as described above.

Test creator interface 200 can also include a list of the components in the test. In some embodiments, test creator interface 200 can be displaying components of a previous created test either created by the user or shared with the user. In other embodiments, test creator interface 200 can be displaying components of a test currently being created by the user.

Each component in the test can be associated with a component type 220, which represents the component type selected upon creation of the component. In some embodiments, each component in the test can be associated with a component name 230, which represents a name either automatically assigned or assigned by the user to each component upon creation. Various components in the test can also be associated with a component input 240, which represents an input selected by the user to be used during the testing.

The example test creator interface depicted in FIG. 2 is merely an example, and is not intended to be limiting. In various embodiments, test creator interface 200 can include additional or fewer component types, components, and/or features, can include additional information and/or options, etc.

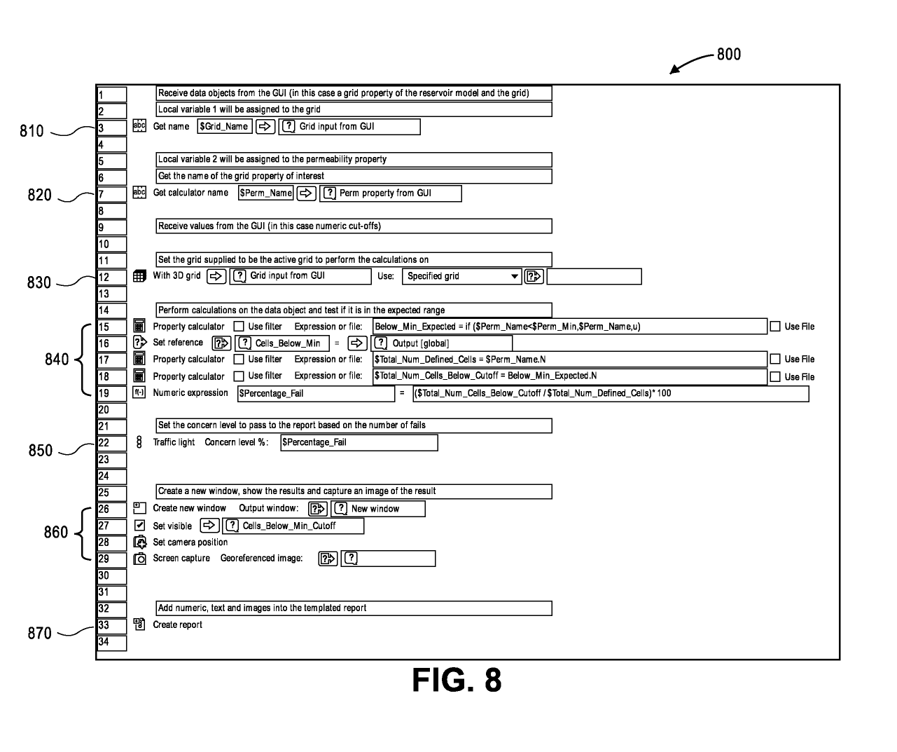

FIG. 8 is a schematic depicting an example of code in a macro programming language used to generate a test, consistent with certain disclosed embodiments. The code 800 can be generated by a user using the test creation interface. The code 800 can represent an example of receiving data objects from a GUI of an E&P software system, where the data objects are grid properties of a reservoir model.

Code segment 810 can represent instructions to assign a local variable to the grid input from the GUI.

Code segment 820 can represent instructions to assign a local variable to a permeability property, and retrieve the name of the grid property of interest.

Code segment 830 can represent instructions to receive values from the GUI and can set a grid supplied from the GUI to be the active grid to perform the calculations on.

Code segment 840 can represent instructions to perform calculations on the data object and test whether it is in an expected range.

Code segment 850 can represent instructions to set a concern level of a report statistics component based on a number of fails.

Code segment 860 can represent instructions to create a new window, show results of the test, and capture an image of the results.

Code segment 870 can represent instructions to create a report.

The code depicted in FIG.8 is merely an example, and is not intended to be limiting. In various embodiments, code 800 can include additional or fewer code segments can include additional information, instructions, and/or options, etc.

FIG. 3 is a schematic depicting an example report creator interface, consistent with certain disclosed embodiments. Report creator interface 300 can be, for example, an HTML webpage displayed on a web browser, a stand-alone application, or an editable document in a word processor running on a user's computer.

Report creator interface 300 can include text and display elements associated with results and components. The display elements can be selected by a user and the text can be entered by the user and added to the report template.

In some embodiments, report creator interface 300 can include text and display elements of a previous created report template either created by the user or shared with the user. In other embodiments, report creator interface 300 can include text and display elements of a report template currently being created by the user.

Text 310 can represent a textual string added to the report template by the user. Display element 320 can be associated with an image component that is populated when the test is run and the report is generated. Display element 330 can be associated with a report statistics component that is populated with a value based on analyzing the results of testing one or more screen capture components. The value can be populated when the test is run and the report is generated. Display element 330 can also include a pass/fail/caution indicator 330A that has a color set based by comparing the value with a threshold and assigning a pass value, a fail value, or a caution value to display element 330A. Display element 340 can represent a screen capture component that is populated with data created by the software system. Display element 340 can be populated when the test is run and the report is generated.

The example report creator interface depicted in FIG. 3 is merely an example, and is not intended to be limiting. In various embodiments, report creator interface 300 can include additional or fewer display elements, component types, components, and/or features, can include additional information and/or options, etc.

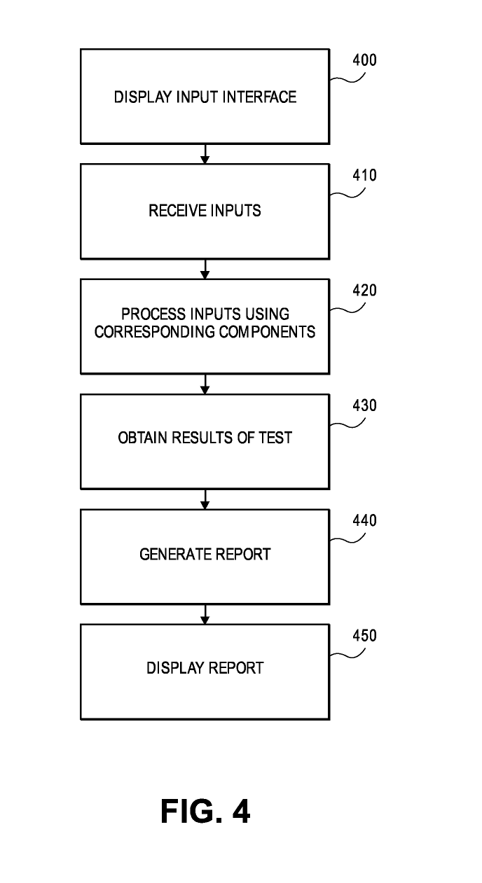

FIG. 4 is a flow diagram illustrating an example of using a test and report template, consistent with certain disclosed embodiments. The method can be performed on a computing device, such as a computing device configured and/or designed to run a specific software system. For example, the computing device can be configured to run an E&P software system.

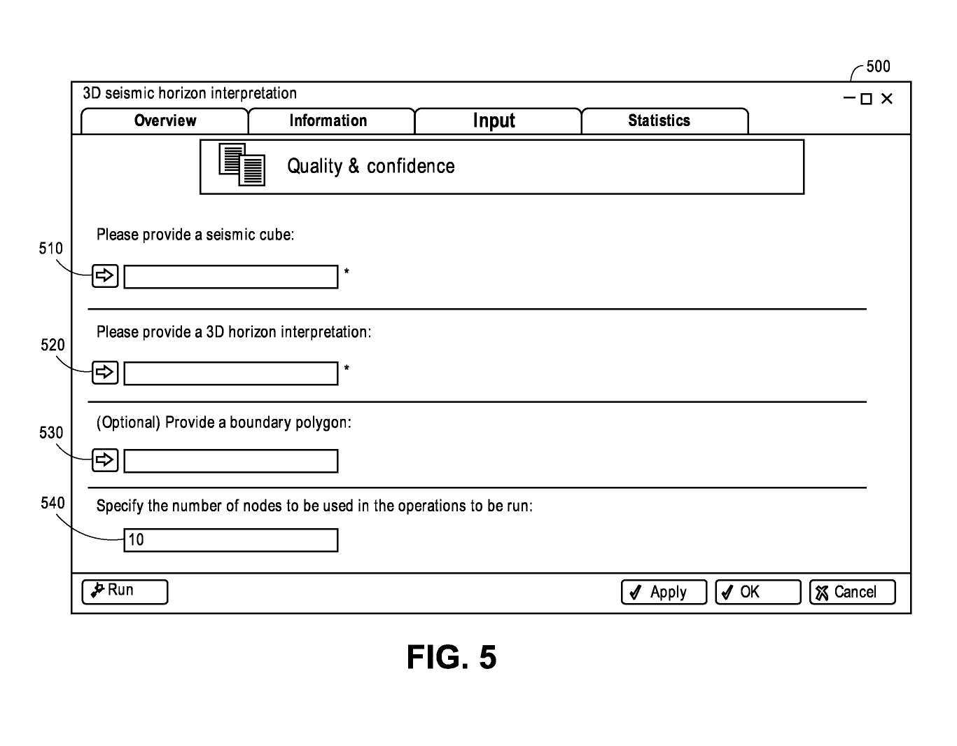

The example of a method shown can begin in 400, when the computing device displays an input interface for a user. An example input interface is shown in FIG. 5. In some embodiments, the input interface is generated based on the inputs associated with the components selected during the test creation. Accordingly, an indication of each input can be displayed with an area for the user to enter the appropriate input. (e.g., files, memory locations of files, network locations of files, text, etc.).

In 410, the computing device can receive inputs from the user. For example, the computing device can receive text, files (e.g. images or proprietary files of the software system), memory locations of files, network locations of files, etc. from the user.

In 420, the computing device can process the inputs using the corresponding components to perform the testing. In some embodiments, the computing device can process the inputs using the testing rules associated with the test (e.g., input by the user in 125 of FIG. 1). For example, the test can evaluate a match between supplied data object data values and expected value ranges for that object type.

In 430, the computing device can obtain and/or determine the results of the testing.

In 440, the computing device can generate a report based on the results of the testing and a report template. For example, the generated report can be based on the report template created in FIG. 1, and values, images, and/or text can be inserted into each display element. For example, a pass, fail, or caution value can be assigned to a pass/fail/caution report statistic and a color can be assigned to the display element based on the pass/fail/caution value. In some embodiments, the report can be generated based on the publication format selected by the user in FIG. 1 (e.g., a word processing document, an HTML webpage, etc.).

In 450, the computing device can display the report. In some embodiments, the report can be displayed on the user's device and/or shared with other users. For example, the computing device can receive a list of users and/or a publication level for sharing the generated report. In some embodiments, the user can provide a list of one or more usernames of users that use the same software system for sharing the generated report. In other embodiments, the user can specify a publication level for sharing the generated report. Examples of publication levels include, but are not limited to, global publication (i.e., no restrictions), publication within an organization, publication within a specific division of an organization, publication to a predetermined group of users, etc.

While the operations depicted in FIG. 4 have been described as performed in a particular order, the order described is merely an example, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. For example, 420-430 are described as discrete steps for the sake of example, but processing and obtaining results of the test can, in some embodiments, be a single operation. Further, the operations described are not intended to be exhaustive or absolute, and various operations can be inserted or removed.

FIG. 5 is a schematic depicting an example input interface, consistent with certain disclosed embodiments. Input interface 500 can be, for example, an HTML webpage displayed on a web browser or a stand-alone application running on a user's computer.

Input interface 500 can include a listing of inputs. Each input can be associated with a component, as described above, and can also be associated with a description. In the example shown in FIG. 5, the description can be used to provide instructions to the user on which inputs to enter

As depicted in FIG. 5, input interface 500 lists four inputs 510-540. Input 510 and input 520 can be associated with one or more components that call for an input, and the user can, for example, select a local file location or a remote file location to enter into input interface 500. Input 530 can be associated with one or more components that do not call for an input but can optionally be associated with an input. The user can, for example, select a local file location or a remote file location to enter into input interface 500 for input 530. Input 540 can be associated with one or more components that call for an input and the user can, for example, enter a number into input interface 500.

Based on the information, files, file locations, and/or text received via input interface 500, the computing device can perform the testing.

The example input interface depicted in FIG. 5 is merely an example, and is not intended to be limiting. In various embodiments, the input interface can include additional or fewer inputs, input types, and/or features, can include additional information and/or options, etc.

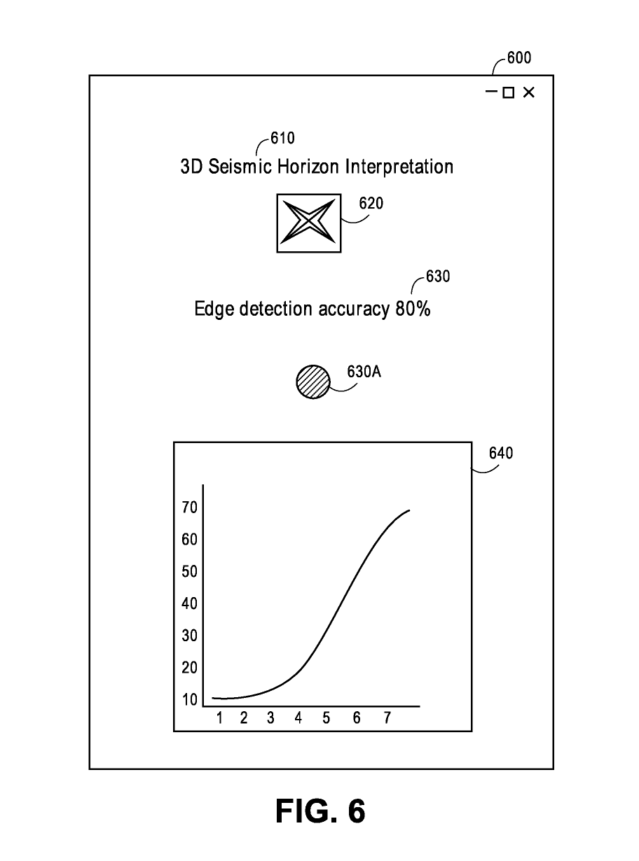

FIG. 6 is a schematic depicting an example report, consistent with certain disclosed embodiments. Report 600 can be displayed via, for example, an HTML webpage on a web browser or a stand-alone application running on a user's computer. Report 600 can include display elements 610-640 and can represent a generated report based on the report template in FIG. 3.

Display element 610 can represent a textual string in the report. Display element 620 can be a populated image from an image component. Display element 630 can represent a populated value from a report statistics component that is populated based on analyzing the results of testing one or more screen capture components. As shown in FIG. 6, the populated value is 80%. Display element 630 can also include a pass/fail/caution indicator 630A that has a color set by comparing the populated value with a threshold and assigning a pass value, a fail value, or a caution value to the display element. For example, if the populated value is compared to a threshold value of 60%, a pass value can be assigned to the display element and the display element can be set to a green color in the generated report. Display element 640 can represent a screen capture component that is populated with data created by the software system.

The example report depicted in FIG. 6 is merely an example, and is not intended to be limiting. In various embodiments, the report can include additional or fewer display elements, component types, components, and/or features, can include additional information and/or options, etc.

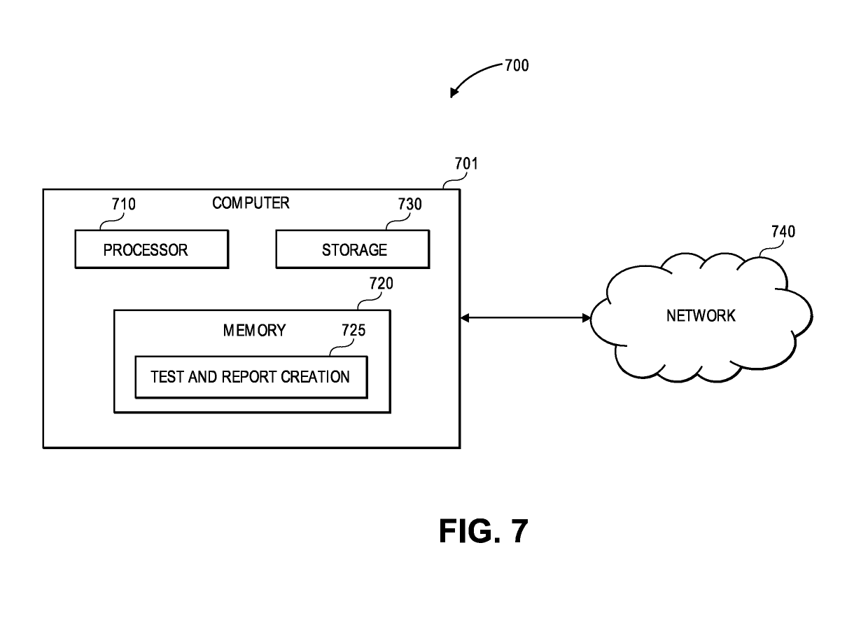

FIG. 7 is a diagram illustrating an example of a hardware system for providing a test and report creation system, consistent with certain disclosed embodiments. The example system 700 includes example system components that may be used. The components and arrangement, however, may be varied.

A computer 701 may include a processor 710, a memory 720, storage 730, and input/output (I/O) devices (not pictured). The computer 701 may be implemented in various ways and can be configured to perform any of the embodiments described above. For example, the computer 701 may be a general purpose computer, a mainframe computer, a specialized test and report creation computer, any combination of these components, or any other appropriate computing device. The computer 701 may be standalone, or may be part of a subsystem, which may, in turn, be part of a larger system.

The processor 710 may include one or more processing devices, such as, for example, a microprocessor from the Intel Core™ family manufactured by Intel™, the Phenom™ family manufactured by AMD™, or the like. Memory 720 may include one or more non-transitory storage devices configured to store information and/or instructions used by processor 710 to perform certain functions and operations related to the disclosed embodiments, such as the methods of FIGS. 1 and 4. Storage 730 may include a volatile, non-volatile, non-transitory, magnetic, semiconductor, tape, optical, removable, non-removable, or other type of computer-readable medium used as a storage device. In some embodiments, storage 730 can store components, files, created tests, testing rules, report templates, generated reports, etc.

In one embodiment, memory 720 may include one or more programs or subprograms including instructions that may be loaded from storage 730 or elsewhere that, when executed by computer 701, perform various procedures, operations, or processes consistent with disclosed embodiments. For example, memory 720 may include a test and report creation program 725 for creating and performing tests, creating report templates, and displaying reports, according to various disclosed embodiments. Memory 720 may also include other programs that perform other functions, operations, and processes, such as programs that provide communication support, Internet access, etc. The test and report creation program 725 may be embodied as a single program, or in some embodiments, may include multiple sub-programs that, when executed, operate together to perform the functions and operations of the test and report creation program 725 according to disclosed embodiments. In some embodiments, test and report creation program 725 can perform the processes and operations of FIGS. 1 and 4 described above.

The computer 701 may communicate over a link with a network 740. For example, the link may be a direct communication link, a local area network (LAN), a wide area network (WAN), or other suitable connection. The network 740 may include the Internet, as well as other networks, which may be connected to various systems and devices.

The computer 701 may include one or more input/output (I/O) devices (not pictured) that allow data to be received and/or transmitted by the computer 701. I/O devices may also include one or more digital and/or analog communication I/O devices that allow the computer 701 to communicate with other machines and devices. I/O devices may also include input devices such as a keyboard or a mouse, and may include output devices such as a display or a printer. The computer 701 may receive data from external machines and devices and output data to external machines and devices via I/O devices. The configuration and number of input and/or output devices incorporated in I/O devices may vary as appropriate for various embodiments.

Example uses of the system 700 can be described by way of example with reference to the example embodiments described above.

While the teachings has been described with reference to the example embodiments, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A system comprising:
a processing system of a device comprising one or more processors; and
a memory system comprising one or more computer-readable media, wherein the one or more computer-readable media contain instructions that, when executed by the processing system, cause the processing system to perform operations comprising:
displaying a test creator interface for creating a test;
receiving, via the test creator interface, a selection of one or more components of the test;
receiving, via the test creator interface, indications of one or more inputs of the test, wherein each input of the one or more inputs is associated with a component of the one or more components;
receiving testing rules corresponding to the one or more components and the one or more inputs of the test, wherein the testing rules are associated with one or more results;
displaying a report creator interface for creating a report template associated with the test; and
receiving, via the report creator interface, instructions for displaying the one or more results in the report template.

2. The system of claim 1, the operations further comprising;
receiving an indication of a level of publication of the test and the report template;
determining a list of users for sharing the test and the report template based on the level of publication; and
providing the test and the report template to each user in the list of users.

3. The system of claim 1, the operations further comprising:
displaying an input interface associated with the test;
receiving user inputs from a user for each of the one or more inputs of the test;
processing the user inputs based on the testing rules to obtain the one or more results; and
generating a report based on the report template and the instructions for displaying the one or more results.

4. The system of claim 3, the operations further comprising:
receiving an indication of a level of publication of the report;
determining a list of users for sharing the report based on the level of publication; and
providing the report to each user in the list of users.

5. The system of claim 1, the operations further comprising receiving, via the report creator interface, instructions for displaying indications of the one or more components.

6. The system of claim 1, wherein the test creator interface and the report creator interface comprise a drag and drop interface.

7. The system of claim 1, wherein at least one of receiving the selection of the one or more components, receiving indications of the one or more inputs, receiving the testing rules, and receiving instructions for displaying the one or more results is based on receiving instructions from a user in a macro programming language.

8. The system of claim 1, the operations further comprising receiving a publication format associated with the report template.

9. A computer-implemented method, comprising:
displaying, using one or more processors, a test creator interface for creating a test;
receiving, via the test creator interface, a selection of one or more components of the test;
receiving, via the test creator interface, indications of one or more inputs of the test, wherein each input of the one or more inputs is associated with a component of the one or more components;
receiving testing rules corresponding to the one or more components and the one or more inputs of the test, wherein the testing rules are associated with one or more results;
displaying a report creator interface for creating a report template associated with the test; and
receiving, via the report creator interface, instructions for displaying the one or more results in the report template.

10. The method of claim 9, further comprising;
receiving an indication of a level of publication of the test and the report template;
determining a list of users for sharing the test and the report template based on the level of publication; and
providing the test and the report template to each user in the list of users.

11. The method of claim 9, further comprising:
displaying an input interface associated with the test;
receiving user inputs from a user for each of the one or more inputs of the test;
processing the user inputs based on the testing rules to obtain the one or more results; and
generating a report based on the report template and the instructions for displaying the one or more results.

12. The method of claim 11, further comprising:
receiving an indication of a level of publication of the report;
determining a list of users for sharing the report based on the level of publication; and
providing the report to each user in the list of users.

13. The method of claim 9, further comprising receiving, via the report creator interface, instructions for displaying indications of the one or more components.

14. The method of claim 9, wherein the test creator interface and the report creator interface comprise a drag and drop interface.

15. The method of claim 9, wherein at least one of receiving the selection of the one or more components, receiving indications of the one or more inputs, receiving the testing rules, and receiving instructions for displaying the one or more results is based on receiving instructions from a user in a macro programming language.

16. The method of claim 9, further comprising receiving a publication format associated with the report template.

17. A non-transitory computer readable storage medium comprising instructions for causing one or more processors to:
display a test creator interface for creating a test;
receive, via the test creator interface, a selection of one or more components of the test;
receive, via the test creator interface, indications of one or more inputs of the test, wherein each input of the one or more inputs is associated with a component of the one or more components;
receive testing rules corresponding to the one or more components and the one or more inputs of the test, wherein the testing rules are associated with one or more results;
display a report creator interface for creating a report template associated with the test; and
receive, via the report creator interface, instructions for displaying the one or more results in the report template.

18. The non-transitory computer readable storage medium of claim 17, the instructions further causing the one or more processors to:
receive an indication of a level of publication of the test and the report template;
determine a list of users for sharing the test and the report template based on the level of publication; and
provide the test and the report template to each user in the list of users.

19. The non-transitory computer readable storage medium of claim 17, the instructions further causing the one or more processors to:
display an input interface associated with the test;
receive user inputs from a user for each of the one or more inputs of the test;
process the user inputs based on the testing rules to obtain the one or more results; and
generate a report based on the report template and the instructions for displaying the one or more results.

20. The non-transitory computer readable storage medium of claim 19, the instructions further causing the one or more processors to:
receive an indication of a level of publication of the report;
determine a list of users for sharing the report based on the level of publication; and
provide the report to each user in the list of users.
